(19) United States
(12) Patent Application Publication
(10) Pub. No.: US 2019/0362621 A1
(43) Pub. Date: Nov. 28, 2019

(54) APPLIANCE WITH USER PRESENCE DETECTION AND USER-SPECIFIC OPERATION

(71) Applicant: Haier US Appliance Solutions, Inc., Wilmington, DE (US)

(72) Inventor: Jeff Donald Drake, Louisville, KY (US)

(21) Appl. No.: 15/989,566

(22) Filed: May 25, 2018

(51) Int. Cl. G08C 17/02; H04B 17/318

(52) U.S. Cl. CPC G08C 17/02; G06F 17/30864; H04B 17/318

(57) ABSTRACT

A method of operating an appliance includes receiving a user credential. The method also includes receiving a unique identifier associated with the appliance via a short-range radio signal. The method further includes detecting that a distance between the appliance and a remote user interface device is less than a distance threshold based on a received signal strength indicator of the short-range radio signal. The method also includes activating the appliance with a predetermined customized operating parameter. The predetermined customized operating parameter is based on the unique identifier associated with the appliance and the user credential.

### FIELD OF THE INVENTION

The present subject matter relates generally to household appliances which can detect a user proximate to the appliances. The present subject matter also relates generally to household appliances which operate with predetermined settings which are customized to the specific user detected.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances. Generally, a user must manually activate such appliances in order to utilize the basic functions of the appliances.

Some household appliances can also include features for automating some or all of the basic functions of the appliance. Such appliances generally operate in response to the detected presence of the user but are not specific to the user. For example, the appliance may be able to detect the presence of any user, but is generally not able to distinguish one user from another or provide customized automation based on an identity of the user.

Accordingly, there exists a need for an appliance with improved user detection and greater responsiveness to the detected user.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of operating an appliance is provided. The method includes receiving a user credential. The method also includes receiving a unique identifier associated with the appliance via a short-range radio signal and detecting that a distance between the appliance and a remote user interface device is less than a distance threshold based on a received signal strength indicator of the short-range radio signal. The method further includes sending the received user credential and the unique identifier from the remote user interface device to a remote database and receiving a predetermined customized operating parameter based on the unique identifier associated with the appliance and the user credential from the remote database with a controller of the appliance. The method also includes activating the appliance with a predetermined customized operating parameter. The predetermined customized operating parameter is based on the unique identifier associated with the appliance and the user credential.

In accordance with another embodiment of the present disclosure, a method of operating an appliance is provided. The method includes receiving a user credential. The method also includes receiving a unique identifier associated with the appliance via a short-range radio signal and detecting that a distance between the appliance and a remote user interface device is less than a distance threshold based on a received signal strength indicator of the short-range radio signal. The method further includes sending the received user credential and the unique identifier from the remote user interface device to a remote database and receiving a predetermined custom setting based on the unique identifier and the user credential from the remote database with a controller of the appliance. The method also includes modifying an operating parameter of the appliance to a predetermined custom setting. The predetermined custom setting is based on the unique identifier associated with the appliance and the user credential.

In accordance with yet another embodiment of the present disclosure, an appliance is provided. The appliance includes a cabinet. The cabinet defines a vertical direction, a lateral direction and a transverse direction that are mutually perpendicular. A user interface panel is positioned on an exterior of the cabinet. The appliance also includes a controller configured to communicate wirelessly with a remote user interface device and a remote database. The controller is configured to transmit a unique identifier to the remote user interface device via a short-range radio signal and to receive a predetermined customized operating parameter from the remote database. The controller is also configured to activate the appliance with the predetermined customized operating parameter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of exemplary laundry appliances in accordance with one or more embodiments of the present disclosure.

FIG. 2 provides a partial perspective view of an exemplary air conditioner appliance in accordance with additional embodiments of the present disclosure.

FIG. 3 provides a perspective view of an oven appliance in accordance with additional embodiments of the present disclosure.

FIG. 4 provides a perspective view of a microwave oven appliance in accordance with additional embodiments of the present disclosure.

FIG. 5 provides a perspective view of a refrigeration appliance in accordance with additional embodiments of the present disclosure.

FIG. 6 provides a front view of a dishwashing appliance in accordance with additional embodiments of the present disclosure.

FIG. 7 provides a schematic diagram of an appliance in communication with a remote user interface device and a remote database according to one or more embodiments of the present disclosure.

FIG. 8 provides a flowchart illustrating an example method of operating an appliance according to one or more embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

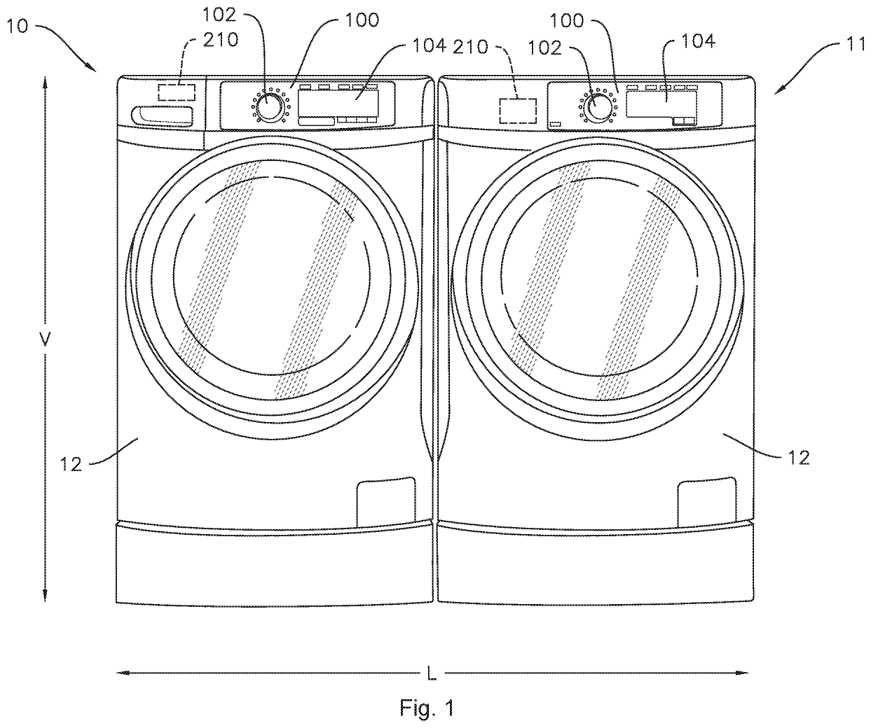

As may be seen in FIGS. 1 through 6, in accordance with one or more embodiments of the present subject matter, an appliance 10 having a cabinet 12 is provided. The cabinet 12 defines a vertical direction V, a lateral direction L and a transverse direction T that are mutually perpendicular. The cabinet 12 extends between a top portion 13 and a bottom portion 14 along the vertical direction V. Cabinet 12 also extends between a first side portion 15 and a second side portion 16, e.g., along the lateral direction L, and a front portion 17 and a back portion 18, e.g., along the transverse direction T.

A user interface panel 100 and a user input device 102 may be positioned on an exterior of the cabinet 12. The user input device 102 is generally positioned proximate to the user interface panel 100, and in some embodiments, the user input device 102 may be positioned on the user interface panel 100. The appliance 10 may also include features for detecting the presence of a user, as will be described in more detail below.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, the appliance 10 may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance 10. Operation of the appliance 10 can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance 10. Controller 210 may include a memory and one or more microprocessors, CPUs or the like, such as general or special purpose microprocessors operable to execute programming instructions or micro-control code associated with operation of the appliance 10. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance 10 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the appliance 10 may be one of a set of two or more appliances. In the exemplary embodiment illustrated in FIG. 1, appliance 10 may be one of a pair of laundry appliances, e.g., the appliance may be a washer 10 and/or dryer 11. In embodiments such as illustrated in FIG. 1, the user input device 102 of each appliance 10 and 11 may be positioned on the user interface panel 100. The embodiment illustrated in FIG. 1 also includes a display 104 on the user interface panel.

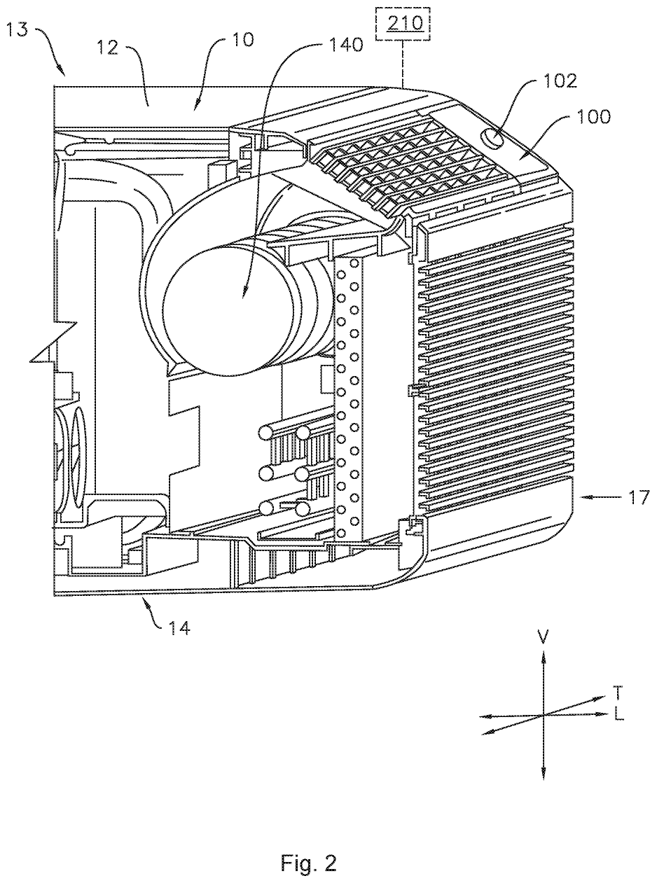

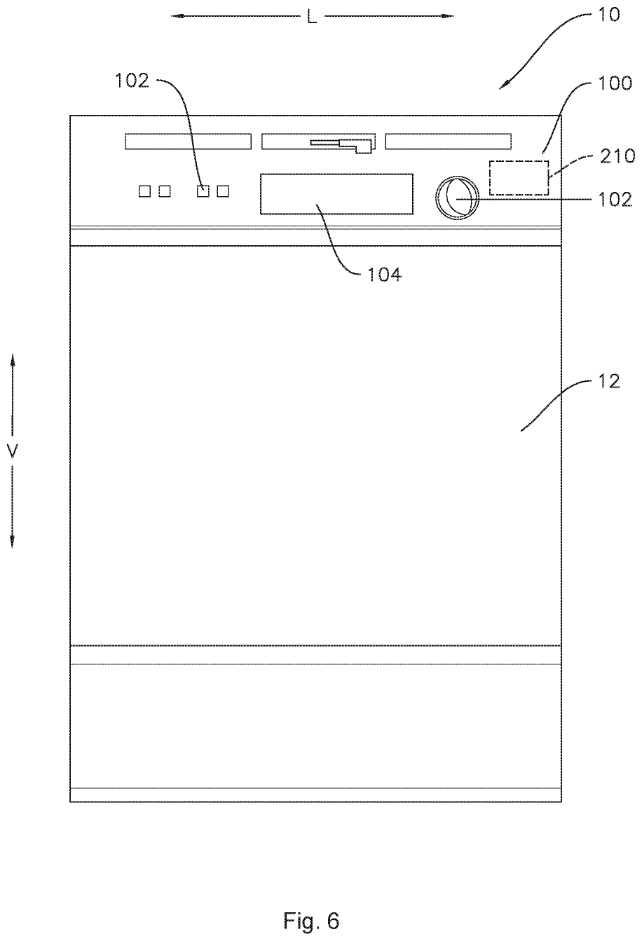

FIG. 2 illustrates another example embodiment of the appliance 10, wherein the appliance 10 is a room air conditioner. As illustrated, the exemplary air conditioner 10 includes cabinet 12, user interface panel 100 and user input device 102. In the illustrated example of FIG. 2, the user input device 102 is a control knob, similar to those illustrated in FIGS. 1 and 6. The air conditioner 10 may also include a controller 210, and the controller 210 may be configured to activate the air conditioner 10, e.g., by turning on fan 140 to circulate air.

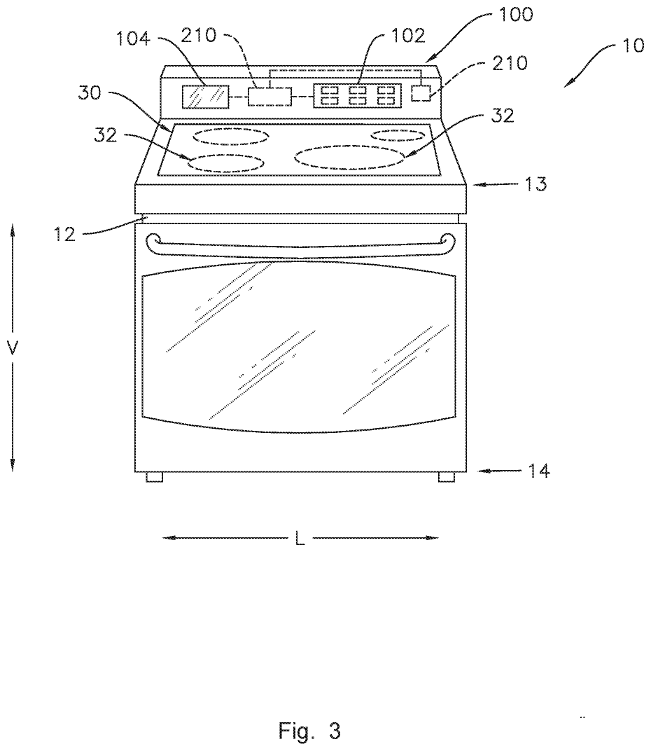

FIG. 3 illustrates another example embodiment of the appliance 10, wherein the appliance 10 is an oven appliance including a cooktop and an oven. The exemplary oven appliance 10 illustrated in FIG. 3 includes user interface panel 100 and user input device 102. In the illustrated example of FIG. 3, the user input device 102 is a touch screen interface. Oven appliance 10 is provided by way of example only and is not intended to limit the present subject matter in any aspect. Thus, the present subject matter may be used with other oven appliance configurations, e.g., that define one or more interior cavities for the receipt of food and/or having different heating element arrangements than what is shown in FIG. 3. Further, the present subject matter may be used in a stand-alone cooktop, a hot plate, or any other suitable appliance.

As illustrated in FIG. 3, the exemplary oven appliance 10 generally includes a cooking assembly. The cooking assembly may include one or more heating elements. For example, in some embodiments, the cooking assembly includes cabinet 12 which in some embodiments may be an insulated cabinet 12 with an interior cooking chamber (not shown) configured for the receipt of one or more food items to be cooked defined within insulated cabinet 12. Such cooking chambers are generally understood by those of ordinary skill in the art and are not described in further detail herein. The oven appliance 10 may additionally include a cooktop 30. Cooktop 30 may be disposed on the cabinet 12 generally at or proximate to top portion 13. Cooktop 30 includes one or more heating assemblies 32, e.g., electric heating elements or gas burners, thereon.

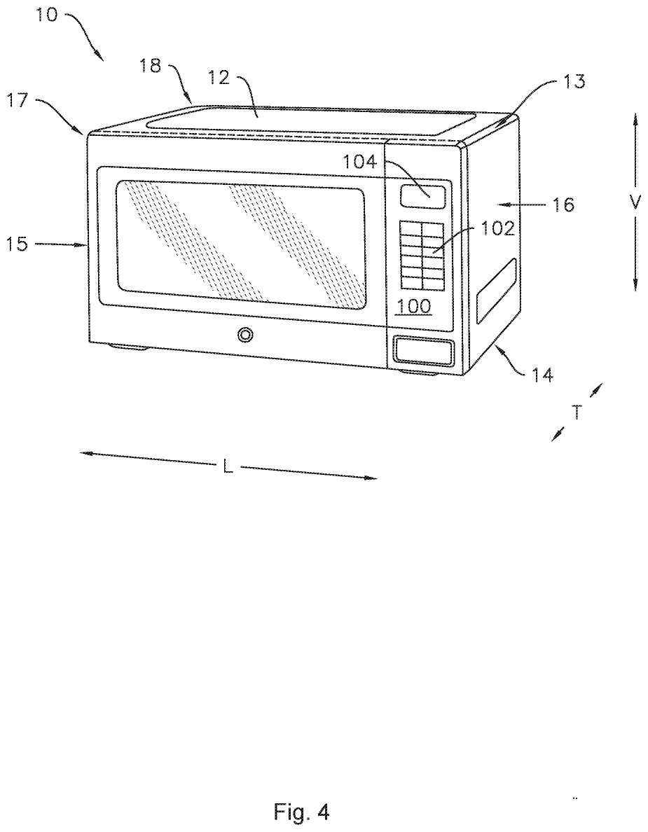

In another example embodiment, the appliance 10 may be a microwave oven appliance, such as is illustrated in FIG. 4. It should be understood that microwave oven appliance 10 is provided by way of example only. Thus, the present subject matter is not limited to microwave oven appliance 10 and may be utilized in any suitable appliance.

Microwave oven appliance 10 includes a cabinet 12. A cooking chamber is defined within the cabinet 12 of the microwave 10. Microwave 10 of FIG. 4 is configured to heat articles, e.g., food or beverages, within the cooking chamber using electromagnetic radiation. Microwave appliance 10 may include various components which operate to produce the electromagnetic radiation, as is generally understood. For example, microwave appliance 10 may include a magnetron (such as, for example, a cavity magnetron), a high voltage transformer, a high voltage capacitor and a high voltage diode. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to the cooking chamber. The structure and intended function of microwave ovens are generally understood by those of ordinary skill in the art and are not described in further detail herein.

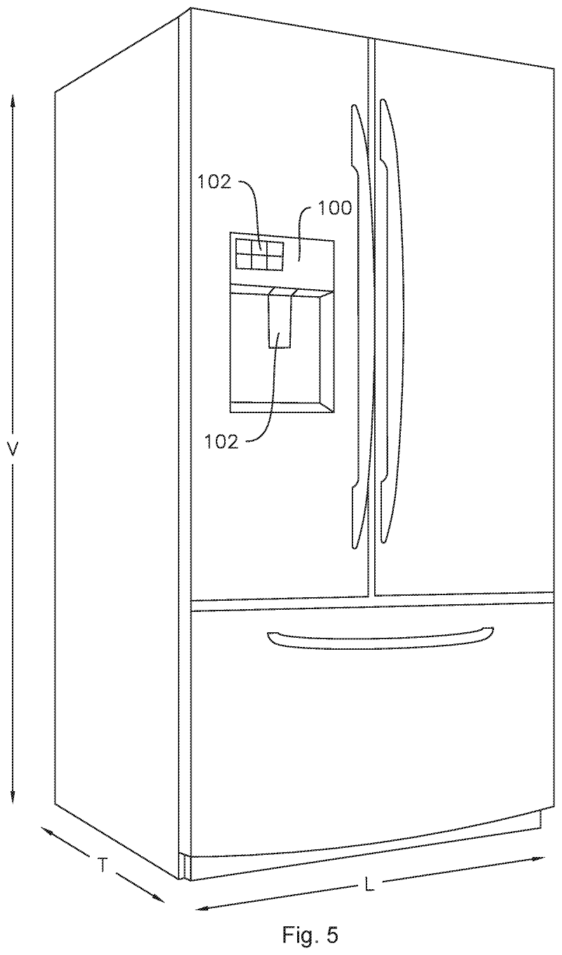

In another embodiment, the appliance 10 may be a refrigerator appliance, such as is illustrated in FIG. 5. FIG. 5 provides a perspective view of a refrigerator appliance 10 according to an exemplary embodiment of the present subject matter. Refrigerator appliance 10 includes a cabinet 12. The example refrigerator appliance 10 depicted in FIG. 5 is generally referred to as a bottom mount refrigerator appliance. However, it should be understood that refrigerator appliance 10 is provided by way of example only. Thus, the present subject matter is not limited to refrigerator appliance 10 and may be utilized in any suitable appliance, including without limitation, side-by-side style refrigerator appliances or top mount refrigerator appliances as well.

Refrigerator appliance 10 may also include a dispensing assembly for dispensing, e.g., liquid water and/or ice to, for example, a dispenser recess defined on the exterior of cabinet 12, as is generally understood in the art. Thus, in some embodiments, the appliance 10 may be a refrigerator appliance and the user interface panel 100 may be or include a control panel of the dispensing assembly. Further with reference to the exemplary embodiment illustrated in FIG. 5, in some exemplary embodiments including refrigerator appliance 10 and a dispensing assembly, the user input device 102 may be a paddle of the dispensing assembly, the paddle 102 in FIG. 5 being an exemplary embodiment of the user input device. Such dispensing assemblies, including actuators therefor such as paddles, levers, etc., are generally understood in the art and are not described further herein.

FIG. 6 provides a front view of a dishwashing appliance 10 according to yet another exemplary embodiment of the present subject matter. The dishwashing appliance includes a cabinet 12 with a user interface panel 100 thereon. In the illustrated example embodiment of the FIG. 6, the user interface panel includes multiple user input devices 102, e.g., a knob and a plurality of buttons, as well as a display 104. In various embodiments, any suitable combination of any one or more of the illustrated user input devices 102 and display 104 may be provided.

According to various embodiments of the present disclosure, the appliance 10 may take the form of any of the examples described above, or may be any other household appliance where improved user detection and greater responsiveness to the detected user is desired. Thus, it will be understood that the present subject matter is not limited to any particular household appliance.

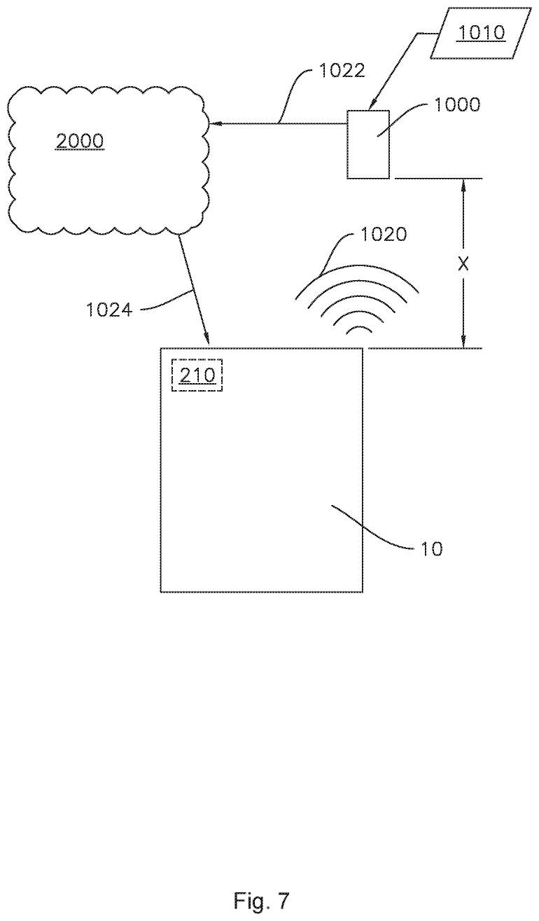

Turning now to FIG. 7, the appliance 10, and in particular, controller 210 thereof, may be configured to communicate with a separate device external to the appliance, such as a communications device or other remote user interface device 1000. The remote user interface device 1000 may be a laptop computer, smartphone, tablet, personal computer, wearable device, smart home system, and/or various other suitable devices. The appliance 10, e.g., controller 210 thereof, may also be configured to communicate with a remote database 2000, such as a cloud server. The appliance 10 may be in communication with the remote user interface device 1000 device through various possible communication connections and interfaces.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

The appliance 10 and the remote user interface device 1000 may be matched in wireless communication, e.g., connected to the same wireless network. The appliance 10 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the appliance 10 and the remote user interface device 1000. For example, BLUETOOTH® Low Energy may advantageously minimize the power consumed by the exemplary methods and devices described herein due to the low power networking protocol of BLUETOOTH® Low Energy. As another example, BLUETOOTH® Low Energy may advantageously provide improved accuracy in determining a distance X between the remote user interface device 1000 and the appliance 10, which can allow the user to set the distance they wish to trigger actions on certain appliances. For instance, BLUETOOTH® Low Energy is more accurate than GPS and may provide fine grained location and distance from an appliance 10 and/or a particular appliance 10 of interest out of multiple appliances 10, e.g., in a kitchen.

Still with reference to FIG. 7, the remote user interface device 1000 may receive a user credential 1010 associated with a specific user. For example, receiving the user credential may include requiring or prompting a user to log in to the device 1000 and/or an app or other software running on the remote user interface device 1000. In some embodiments, the remote user interface device 1000 may receive a unique identifier, such as a universally unique identifier (UUID) 1020 from the appliance 10 via the BLUETOOTH® connection. For example, the UUID 1020 of the appliance 10 may be or include a media access control (MAC) address of the appliance 10 and/or a BLUETOOTH® device of the appliance 10. The UUID 1020 may be encoded in a signal, and the remote user interface device 1000 may determine the UUID, e.g., by decoding the signal.

As mentioned above, the appliance 10 may also be configured to communicate wirelessly with a remote database 2000. The remote database 2000 may be, e.g., a cloud-based data storage system. For example, the appliance 10 may communicate with the remote database 2000 over the Internet, which the appliance 10 may access via WI-FI®, such as from a WI-FI® access point in a user's home. In some embodiments, the remote user interface device 1000 may scan for BLUETOOTH® signals including the UUID 1020 associated with the appliance 10. When the appliance 10 and the remote user interface device 1000 are proximate to one another, e.g., when a distance X between the appliance 10 and the remote user interface device 1000 is within, e.g., equal to or less than, a distance threshold, the remote user interface device 1000 may send a signal 1022 to the remote database 2000, e.g., over the Internet via WIFI®. In some embodiments, the proximity of the appliance 10 may be detected within the distance threshold based on a received signal strength indicator of a short-range radio signal, e.g., a BLUETOOTH® signal including the UUID 1020, received from the appliance 10.

The signal 1022 sent to the remote database 2000 may include data encoded therein including the UUID 1020 of the appliance 10 and the user credential 1010 of the user. The remote database 2000 may include a preferred operating parameter or set of parameters which are specific to both the particular appliance 10 identified by the UUID 1020 and the specific user identified by or associated with the user credential 1010. Such preferred operating parameters may include one or more predetermined customized operating parameters or predetermined custom settings 1024. In various embodiments, additional examples of which are described in more detail below, the appliance may be capable of selectively performing one or more cycles and the predetermined customized operating parameters 1024 may be or include a favorite cycle of the specific user identified by or associated with the user credential 1010 for the particular appliance 10 identified by the UUID 1020. The predetermined customized operating parameter 1024 is transmitted to and received by the appliance 10. As shown in FIG. 7, the predetermined customized operating parameter 1024 may be received by the appliance 10 directly from the remote database 2000.

Once the appliance 10 has received the predetermined customized operating parameter 1024, the appliance 10 may modify an operating parameter, e.g., activate the appliance 10 with the predetermined customized operating parameter 1024, e.g., an operating parameter of the appliance 10 may be adjusted to a predetermined custom setting. As mentioned above, the predetermined customized operating parameter 1024 is based on both the UUID 1020 associated with the appliance 10 and the user credential 1000. As such, the operating parameter or setting may be customized in that it is unique and specific to the identified user associated with the user credential 1010.

In some embodiments, systems and methods according to the present subject matter may accommodate multiple users and provide custom settings for each of the multiple users. As a simplified example for purposes of illustration, the multiple users may include a first user and a second user. It is to be understood, however, that the present disclosure is not limited to two users, any number of users may be accommodated with specific custom settings or predetermined customized operating parameters. In some embodiments, the user credential 1010 may be a first user credential associated with a first user and the predetermined customized operating parameter 1024 may be a first predetermined customized operating parameter. Such embodiments may also include receiving a second user credential associated with a second user, and activating the appliance 10 with a second predetermined customized operating parameter based on the universally unique identifier 1020 associated with the appliance 10 and the second user credential. The second predetermined customized operating parameter may be distinct from the first predetermined customized operating parameter in a variety of ways, as described in more detail below with reference to particular example appliances 10.

In embodiments wherein the appliance 10 includes a display 104, the controller 210 may be configured to activate the appliance 10 by turning on or waking the display 104, which may also include providing a customized greeting or other to the specific user on the display 104. In some embodiments, the display 104 may be configured to enter a low-power sleep mode, e.g., wherein the display 104 is dimmed or turned off. For example, in some embodiments where the appliance 10 comprises a display 104, the predetermined customized operating parameter 1024 may include a set of prompts provided on the display 104. As another example, in some embodiments where the appliance 10 comprises a display 104, the predetermined customized operating parameter 1024 may include a message provided on the display 104. For example, in some embodiments, the appliance may provide a customized response for more than one user, e.g., the message provided on the display 104 may be specific to each user of a plurality of users, and the message to be displayed may be determined based on the user credential associated with the particular user. The foregoing is just one example of an improvement in the appliance 10 which provides a customized parameter or setting that is specific to the user detected.

In some embodiments, the appliance 10 may include a light, and the controller may be configured to activate the appliance 10 by turning on the light. For example, the light may be positioned within the drum of the washer 10 or dryer 11 of FIG. 1. As another example, the microwave 10 of FIG. 4 may be an over the range microwave, e.g., positioned above a range appliance such as the oven appliance 10 of FIG. 3. In such embodiments, the over the range microwave 10 may include a light in a bottom portion thereof positioned and configured to illuminate a cooking surface, e.g., such as the cooktop 30 in FIG. 3. Also, the light may be positioned within the cooking chamber of the oven of FIG. 3 or the cooking chamber of the microwave of FIG. 4. In such embodiments, the predetermined customized operating parameter 1024 may include a brightness level of the light. Thus, exemplary methods may include and/or the controller 210 may be configured to modify the brightness level of the light. Modifying the brightness level of the light may include, for example, turning the light on or off or dimming the light or brightening the light. The structure of the light itself is of no particular importance in the present disclosure, is well understood by those of skill in the art, and is not described herein in further detail for the sake of clarity and brevity. Further, in some embodiments, the appliance 10 may be configured to recognize and respond to more than one user, e.g., a first custom operating parameter or setting associated with a first user may include a first brightness level of the light and a second custom operating parameter or setting may include a second brightness level different from the first brightness level. Thus, a brightness level of a light is another example of a predetermined customized operating parameter or setting which may be provided in an improved appliance 10 which not only detects a user but also provides custom features or operation specific to the detected user, e.g., based at least in part on a user credential associated with the user.

In some embodiments, the appliance 10 may be a laundry appliance, e.g., one or both of the washer and dryer 10 and 11 illustrated in FIG. 1. In such embodiments, the predetermined customized operating parameter 1024 may include multiple parameters or parameter settings. For example, the laundry appliance 10 may be configured to perform a selected one of several cycles, such as a cycle including a high temperature wash and low temperature rinse in the case of a washing machine appliance, or a selected one of a high temperature drying cycle, low temperature drying cycle, or tumble dry cycle in the case of a dryer appliance. A frequently used or favorite cycle for the appliance 10, e.g., based on the UUID 1020, may be stored in the remote database 2000 and associated with the user credential 1010. For example, if a particular user most frequently washes a load of whites when using the washing machine, a wash cycle including a high temperature wash may be the favorite cycle associated with that user's user credential 1010. Thus, in some embodiments, an exemplary method may include activating the appliance 10 with the favorite cycle as the predetermined operating parameter 1024. Exemplary embodiments may also include the controller 210 configured to automatically select the favorite cycle when activating the laundry appliance 10 and/or 11. Thus, a favorite cycle of the appliance 10 is another example of a predetermined customized operating parameter or setting which may be provided in an improved appliance 10 according to the present subject matter as described herein throughout.

In some embodiments, the appliance 10 may include a fan. For example, the appliance 10 may be a room air conditioner 10 as in FIG. 2 including a fan 140. In such embodiments, a speed of the fan 140 in FIG. 2 may be determined based on the identity of the user. For example, the predetermined customized operating parameter 1024 may include a speed of rotation of the fan 140. Thus, a speed of rotation of a fan 140 is another example of a predetermined customized operating parameter or setting which may be provided in an improved appliance 10 according to the present subject matter as described herein throughout.

In various embodiments, the appliance 10 may be a cooking appliance such as the oven 10 of FIG. 3 or the microwave 10 of FIG. 4. In such embodiments, the predetermined customized operating parameter 1024 may include one or both of a cooking time and a cooking temperature, such as a power level of an electric heating element 32 in FIG. 3 or of the microwave in FIG. 4. Thus, exemplary methods may include and/or the controller 210 may be configured to automatically selecting a cooking time and a cooking temperature based on the user credential 1010 and the UUID 1020, as yet another example of a predetermined customized operating parameter or setting which may be provided in an improved appliance 10 according to the present subject matter.

As shown in FIG. 5 and described above, the appliance 10 may be a refrigerator appliance 10 including a dispensing assembly. For example, the dispensing assembly in FIG. 5 may be configured to selectively dispense crushed ice or cubed ice, as is generally understood in the art. As another example, the dispensing assembly may be configured to selectively dispense hot or cold water. Such selections may be automatically provided based on the identified user, e.g., the predetermined customized operating parameter 1024 may include one or both of a custom ice dispensing setting or a custom water dispensing setting based on the user credential 1010 and the UUID 1020. In such embodiments, the appliance 10, and in particular the controller 210 thereof, may advantageously be configured to automatically select the user's preferred form of ice or water in response to the received predetermined operating parameter or setting 1024. Further, in some embodiments, a first custom operating parameter or setting associated with a first user credential may be, e.g., crushed ice, and a second custom operating parameter or setting associated with a second user credential may be, e.g., cubed ice. A predetermined custom ice or water dispensing setting is yet another example of a predetermined customized operating parameter or setting which may be provided in an improved appliance 10 which not only detects a user but also provides custom features or operation specific to the detected user, e.g., based at least in part on a user credential associated with the user.

In some embodiments, the appliance 10 may be a dishwashing appliance 10 as described above and shown in FIG. 6. As is generally understood in the art, the dishwashing appliance 10 may be configured to perform a selected one of several cycles similar to the multiple cycles of the laundry appliance 10 and 11 in FIG. 1 described above. In example embodiments where the appliance 10 is the dishwashing appliance 10 of FIG. 6, such cycles may include a normal wash cycle, light and/or heavy wash cycles, pots and pans, etc. In such embodiments, the predetermined customized operating parameter 1024 may include a favorite cycle. Thus, in some embodiments, an exemplary method may include activating the dishwashing appliance 10 with the favorite cycle as the predetermined operating parameter 1024. Exemplary embodiments may also include the controller 210 configured to automatically select the favorite cycle when activating the dishwashing appliance 10.

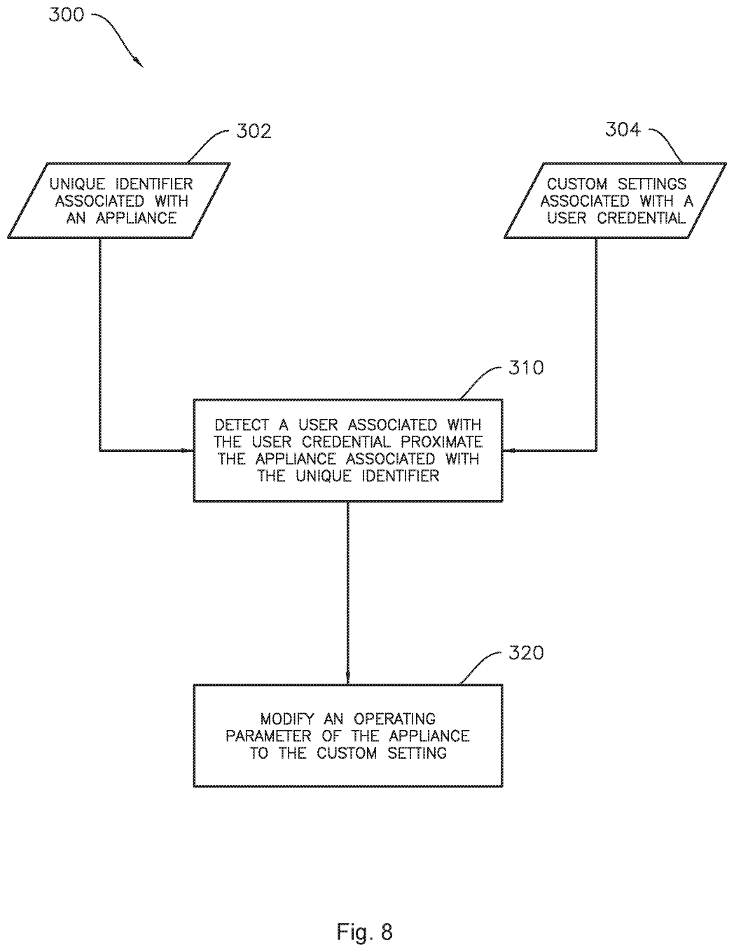

Exemplary methods according to the present subject matter include the method 300 illustrated in FIG. 8. Such methods generally include a BLUETOOTH® beacon or advertisement broadcast by the appliance which includes a unique identifier. The BLUETOOTH® signal from the appliance is scanned by a remote user interface device which then alerts a remote server that the user is within distance of that appliance. The remote server then updates one or more custom settings directly to the appliance. In an exemplary embodiment, a method 300 of operating an appliance may include receiving and/or storing a unique identifier, e.g., a UUID, associated with the appliance at step 302, e.g., from the BLUETOOTH® beacon mentioned above. The UUID of step 302 may be, e.g., a MAC address. The method 300 may also include a step 304 of receiving and/or storing one or more custom settings associated with a user credential. The steps 302 and 304 may include storing the UUID, the user credential and the one or more custom settings in a remote database, e.g., a cloud server. As shown in FIG. 8, the exemplary method 300 may also include a step 310 of detecting a user associated with the user credential proximate the appliance. For example, as mentioned above, the proximity may be detected based on a received signal strength indicator of a BLUETOOTH® signal by a remote user interface device, e.g., smartphone, smartwatch, etc., of the user. In some embodiments, the method 300 may also include sending the user credential and the UUID of the appliance from the remote user interface device to the remote database after detecting the proximity of the user. The appliance may then receive a signal or message from the remote database which includes the custom setting for the appliance, where the remote database is configured to provide said signal or message after looking up both the UUID of the appliance and the user credential of the user to determine the desired custom setting on the specific appliance for this particular user. In various embodiments, the method 300 may include a step 320 of modifying an operating parameter, e.g., brightness of a light, a cycle selection, etc., as discussed above, of the appliance to the custom setting. In some embodiments, the custom setting may be received from the remote database. In other embodiments, the custom setting may be stored in a memory on board the appliance. The appliance may perform at least the steps 310 and 320 as illustrated in FIG. 8, e.g., the appliance may detect the proximity of the user based on the received signal as described above and the controller of the appliance may modify the operating parameter as described above after receiving the custom setting, e.g., from the remote database or a memory of the appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating an appliance, the method comprising:
receiving a user credential;
receiving a unique identifier associated with the appliance via a short-range radio signal;
detecting that a distance between the appliance and the remote user interface device is less than a distance threshold based on a received signal strength indicator of the short-range radio signal;
sending the received user credential and the unique identifier from the remote user interface device to a remote database;
receiving a predetermined customized operating parameter based on the unique identifier associated with the appliance and the user credential from the remote database with a controller of the appliance; and
activating the appliance with the predetermined customized operating parameter received from the remote database.

2. The method of claim 1, wherein the short-range radio signal is a Bluetooth Low Energy signal.

3. The method of claim 1, wherein the user credential is a first user credential associated with a first user and the predetermined customized operating parameter is a first predetermined customized operating parameter, further comprising receiving a second user credential associated with a second user, and activating the appliance with a second predetermined customized operating parameter based on the unique identifier associated with the appliance and the second user credential.

4. The method of claim 1, wherein the appliance comprises a light and the predetermined customized operating parameter comprises a brightness level.

5. The method of claim 1, wherein the appliance comprises a fan and the predetermined customized operating parameter comprises a speed of rotation.

6. The method of claim 1, wherein the appliance comprises a display and the predetermined customized operating parameter comprises a set of prompts provided on the display.

7. The method of claim 1, wherein the appliance comprises a display and the predetermined customized operating parameter comprises a message provided on the display.

8. A method of operating an appliance, the method comprising:
receiving a user credential;
receiving a unique identifier associated with the appliance via a short-range radio signal;
detecting that a distance between the appliance and a remote user interface device is less than a distance threshold based on a received signal strength indicator of the short-range radio signal;
sending the received user credential and the unique identifier from the remote user interface device to a remote database;
receiving a predetermined custom setting based on the unique identifier and the user credential from the remote database with a controller of the appliance; and
modifying an operating parameter of the appliance to the predetermined custom setting received from the remote database.

9. The method of claim 8, wherein the short-range radio signal is a Bluetooth Low Energy signal.

10. The method of claim 8, wherein the user credential is a first user credential associated with a first user and the predetermined custom setting is a first predetermined custom setting, further comprising receiving a second user credential associated with a second user, and activating the appliance with a second predetermined custom setting based on the unique identifier and the second user credential.

11. The method of claim 8, wherein the appliance is an oven appliance, and the step of modifying the operating parameter comprises automatically selecting a cooking time and a cooking temperature.

12. The method of claim 8, wherein the appliance comprises a light, and the step of modifying the operating parameter comprises modifying a brightness level of the light.

13. The method of claim 8, wherein the appliance comprises a fan, and the step of modifying the operating parameter comprises modifying a speed of rotation of the fan.

14. An appliance comprising:
a cabinet defining a vertical direction, a lateral direction and a transverse direction that are mutually perpendicular;
a user interface panel positioned on an exterior of the cabinet; and
a controller configured to communicate wirelessly with a remote user interface device and a remote database, wherein the controller is further configured to:
transmit a unique identifier associated with the appliance to the remote user interface device via a short-range radio signal;
receive a predetermined customized operating parameter from the remote database, wherein the predetermined customized operating parameter is based on the unique identifier associated with the appliance and a user credential; and
activate the appliance with the predetermined customized operating parameter.

15. The appliance of claim 14, wherein the short range radio signal is a Bluetooth Low Energy signal.

16. The appliance of claim 14, wherein the user interface panel comprises a display, and wherein the controller is configured to activate the appliance with the predetermined customized operating parameter by displaying a customized message on the display.

17. The appliance of claim 14, wherein the appliance is a dishwashing appliance, wherein the predetermined customized operating parameter is a favorite cycle, and wherein the controller is further configured to automatically select the favorite cycle when activating the dishwashing appliance.

18. The appliance of claim 14, wherein the appliance is a laundry appliance, wherein the predetermined customized operating parameter is a favorite cycle, and wherein the controller is further configured to automatically select the favorite cycle when activating the laundry appliance.
